(19) United States
(12) Patent Application Publication
(10) Pub. No.: US 2012/0229625 A1
(43) Pub. Date: Sep. 13, 2012

(54) PROVIDING AFFINITY PROGRAM INFORMATION

(75) Inventors: Matthew A. Calman, Charlotte, NC (US); Erik Stephen Ross, Charlotte, NC (US)

(73) Assignee: Bank of America Corporation, Charlotte, NC (US)

(21) Appl. No.: 13/342,062

(22) Filed: Jan. 1, 2012

Related U.S. Application Data
(60) Provisional application No. 61/450,213, filed on Mar. 8, 2011.
(60) Provisional application No. 61/508,980, filed on Jul. 18, 2011.

(51) Int. Cl. H04N 7/18; G06K 9/68

(52) U.S. Cl. 348/135; 382/218; 348/E07.085

(57) ABSTRACT

Systems, methods, and computer program products are provided for using real-time video analysis and AR or the like to assist the user of mobile devices with commerce activities. Through the use of real-time vision object recognition objects, logos, artwork, products, locations and other features that can be recognized in the real-time video stream can be matched to affinity program information regarding the object and/or the user. The affinity program information may be presenting to the user of the mobile device in conjunction with display of the associated object in a live video stream.

### CROSS-REFERENCE TO RELATED APPLICATIONS

This application claims priority to U.S. Provisional Patent Application Ser. No. 61/450,213, filed Mar. 8, 2011, entitled “Real-Time Video Image Analysis Applications for Commerce Activity,” and U.S. Provisional Patent Application Ser. No. 61/508,980, filed Jul. 18, 2011, entitled “Providing Affinity Program Information,” the entirety of each of which is incorporated herein by reference.

### FIELD

In general, embodiments of the invention relate to commerce and, more specifically, to providing affinity program information to a user of a mobile device in conjunction with a live video stream.

### BACKGROUND

Modern handheld mobile devices, such as smart phones or the like, combine multiple technologies to provide the user with a vast array of capabilities. For example, many smart phones are equipped with significant processing power, sophisticated multi-tasking operating systems, and high-bandwidth Internet connection capabilities. Moreover, such devices often have addition features that are becoming increasing more common and standardized features. Such features include, but are not limited to, location-determining devices, such as Global Positioning System (GPS) devices; sensor devices, such as accelerometers; and high-resolution video cameras.

As the hardware capabilities of such mobile devices have increased, so too have the applications (i.e., software) that rely on the hardware advances. One such example of innovative software is a category known as augmented reality (AR), or more generally referred to as mediated reality. One such example of an AR application platform is Layar, available from Layar, Amsterdam, the Netherlands.

The Layar platform technology analyzes location data, compass direction data, and the like in combination with information related to the objects, locations or the like in the video stream to create browse-able “hot-spots” or “tags” that are superimposed on the mobile device display, resulting in an experience described as “reality browsing”.

Therefore, a need exists to further the capabilities of mobile communication devices and, in particular leverage augmented-reality type analysis to provide mobile device user's with greater access to information.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, apparatus systems and computer program products are described herein that provide for using real-time video analysis and AR or the like to assist the user of mobile devices with accessing product offers and the like. Through the use of real-time vision object recognition objects, logos, artwork, products, locations and other features that can be recognized in the video stream can be matched to data associated with affinity programs and/or affinity accounts owned by the user or someone else. In some embodiments, the data that is matched to the images in the video stream is specific to one or more affinity programs associated with the product. In addition, many of the embodiments herein disclosed leverage financial institution data, which is uniquely specific to a financial institution, in providing information to mobile device users in connection with real-time video stream analysis.

According to embodiments of the invention, a method provides affinity information. The method includes identifying, via a computing device processor, which objects in an image captured on a mobile communication device correspond to a product; determining, via a computing device processor, which of one or more products identified in the image have associated affinity information; and presenting, via a display of the live video stream on the mobile communication device, one or more affinity information indicators, each affinity information indicator presented proximate a location of the one or more products determined to have associated affinity information.

In some embodiments, identifying a product comprises identifying one or more images in a video stream captured on a mobile communication device that correspond to one or more products. In some embodiments, identifying a product comprises identifying one or more objects in a still image captured on a mobile communication device that corresponds to one or more products. In some embodiments, identifying a product comprises identifying one or more products based at least in part on global positioning system information associated with the mobile communication device or other information indicating a location of the mobile communication device.

According to embodiments of the invention, an apparatus for providing affinity information includes a computing platform having a processor and a memory in communication with the processor. The apparatus also includes image capture logic stored in the memory, executable by the processor and configured to capture an image, product identification logic stored in the memory, executable by the processor and configured to identify which objects in the image captured by a mobile communication device correspond to a product, affinity information logic stored in the memory, executable by the processor and configured to determine whether the identified product has associated affinity information, and affinity information presentation logic stored in the memory, executable by the processor and configured to present, on a display of the mobile communication device, one or more affinity information indicators, each affinity information indicator presented proximate a location of the product determined to have associated affinity information.

In some embodiments, the product identification logic is configured to identify one or more images in a video stream captured on a mobile communication device that correspond to one or more products. In some embodiments, the product identification logic is configured to identify one or more objects in a still image captured on a mobile communication device that corresponds to one or more products. In some embodiments, the product identification logic is configured to identify one or more products based at least in part on global positioning system information associated with the mobile communication device or other information indicating a location of the mobile communication device.

According to embodiments of the invention, a computer program product includes a non-transitory computer-readable medium having computer-executable instructions for providing affinity information. The instructions include instructions for identifying which objects in an image captured on a mobile communication device correspond to a product, instructions for determining which of one or more products identified in the image have associated affinity information, and instructions for presenting one or more affinity information indicators displayed on the mobile communication device, each affinity information indicator presented proximate a location of the one or more determined products.

In some embodiments, identifying a product comprises identifying one or more images in a video stream captured on a mobile communication device that correspond to one or more products. In some embodiments, identifying a product comprises identifying one or more objects in a still image captured on a mobile communication device that corresponds to one or more products. In some embodiments, identifying a product comprises identifying one or more products based at least in part on global positioning system information associated with the mobile communication device or other information indicating a location of the mobile communication device.

According to embodiments of the invention, a method for providing affinity information includes identifying, via a server in communication with a mobile communication device, which objects in an image captured on a mobile communication device correspond to a product; determining, via the server, which of one or more products identified in the image have associated affinity information; and communicating instructions to the mobile communication device, via the server, for presenting a display of the image on the mobile communication device, one or more affinity information indicators, each affinity information indicator presented proximate a location of the one or more products determined to have associated affinity information.

In some embodiments, identifying a product comprises identifying one or more images in a video stream captured on a mobile communication device that correspond to one or more products. In some embodiments, identifying a product comprises identifying one or more objects in a still image captured on a mobile communication device that corresponds to one or more products. In some embodiments, identifying a product comprises identifying one or more products based at least in part on global positioning system information associated with the mobile communication device or other information indicating a location of the mobile communication device.

According to embodiments of the invention, an apparatus for providing affinity information includes a server having a processor and a memory in communication with the processor. The apparatus also includes communication logic stored in the memory, executable by the processor and configured to receive data from a mobile communication device, the data corresponding to one or more objects in an image captured by the mobile communication device; product identification logic stored in the memory, executable by the processor and configured to identify which objects in the video stream captured by the mobile communication device correspond to a product; affinity information logic stored in the memory, executable by the processor and configured to determine whether the identified product has associated affinity information; and affinity information presentation logic stored in the memory, executable by the processor and configured to communicate instructions for presenting, on a display of the mobile communication device, one or more affinity information indicators, each affinity information indicator presented proximate a location of the product determined to have associated affinity information.

In some embodiments, the product identification logic is configured to identify one or more images in a video stream captured on a mobile communication device that correspond to one or more products. In some embodiments, the product identification logic is configured to identify one or more objects in a still image captured on a mobile communication device that corresponds to one or more products. In some embodiments, the product identification logic is configured to identify a product comprises identifying one or more products based at least in part on global positioning system information associated with the mobile communication device or other information indicating a location of the mobile communication device.

According to embodiments of the invention, a computer program product includes a non-transitory computer-readable medium having computer-executable instructions for execution on a server in communication with a mobile communication device, the instructions for providing affinity information. The instructions include instructions for identifying which objects in an image captured on a mobile communication device correspond to a product; instructions for determining which of one or more products identified in the image have associated affinity information; and instructions for communicating instructions to the mobile communication device for presenting one or more affinity information indicators in an image displayed on the mobile communication device, each affinity information indicator presented proximate a location of the one or more determined products.

In some embodiments, identifying a product comprises identifying one or more images in a video stream captured on a mobile communication device that correspond to one or more products. In some embodiments, identifying a product comprises identifying one or more objects in a still image captured on a mobile communication device that corresponds to one or more products. In some embodiments, identifying a product comprises identifying one or more products based at least in part on global positioning system information associated with the mobile communication device or other information indicating a location of the mobile communication device.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating a mobile device, in accordance with an embodiment of the invention;

FIG. 2 is a block diagram illustrating an AR environment, in accordance with an embodiment of the invention;

FIG. 3 is a block diagram illustrating a mobile device, in accordance with an embodiment of the invention;

FIG. 4 is a block diagram of an apparatus, such as a mobile communication device, configured to present product affinity information in conjunction with display of the product in a live video stream on a mobile communication device, in accordance with embodiment of the present invention;

FIG. 5 is an additional block diagram of an apparatus, such as a server, configured to communicate instructions configured to initiate display of product affinity information on a mobile communication device in conjunction with display of the product in a live video stream on a mobile communication device, in accordance with embodiment of the present invention;

FIG. 6 is a flow diagram illustrating a method for presenting affinity information indicators in conjunction with display of the product in a live video stream on a mobile communication device, in accordance with embodiments of the present invention; and

FIG. 7 is a flow diagram illustrating another method for presenting affinity information indicators in conjunction with display of the product in a live video stream on a mobile communication device, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

As discussed below, affinity accounts, in various instances, may refer to banking accounts, such as demand deposit accounts (DDAs) like checking and/or savings accounts or credit or debit accounts associated with a card or other payment device. The accounts may be considered “affinity” accounts due to an association with an affinity such as an organization, business, non-profit, association or other entity or individual for which some benefit may be bestowed if the owner of the account achieves a predefined goal. For example, in some instances, an affinity account is associated with an affinity of the customer such as a non-profit organization, such as a charitable organization.

In some such instances, the affinity account is organized such that a predetermined threshold of spending using the affinity account triggers an automatic donation to the charitable organization. In various examples, the predetermined threshold may be a relatively low amount or a relatively high amount. In some instances, a donation or other benefit is bestowed on the customer's affinity as a result of every transaction, regarding of the transaction amount, and in other instances, a donation or other benefit is bestowed on the customer's affinity as a result of reaching a threshold after several transaction amounts are summed. In some instances, a group of people are associated and work toward a common goal in order that a donation or other benefit is bestowed on the affinity.

Thus, methods, systems, computer programs and the like provide affinity program information on mobile communication devices in conjunction with a live video stream.

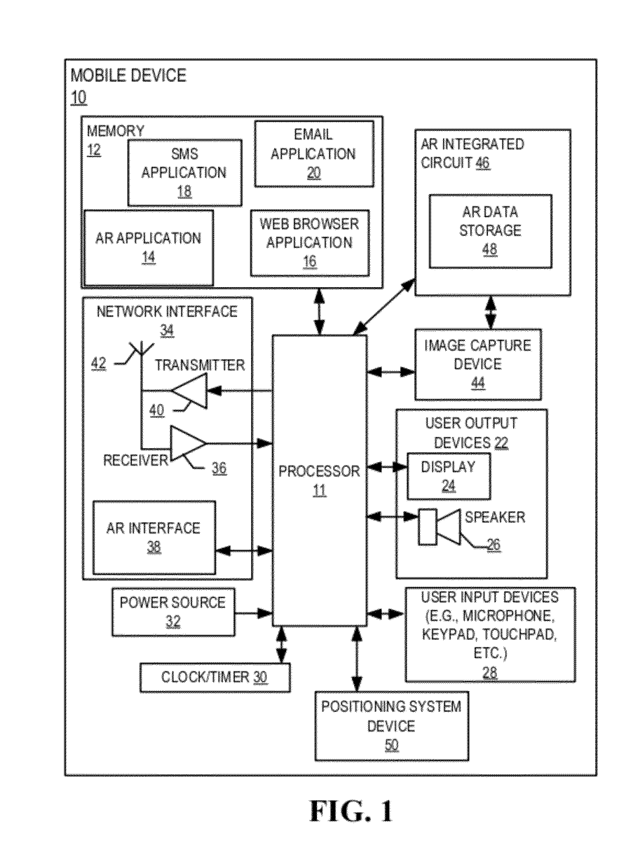

FIG. 1 illustrates an embodiment of a mobile device 10 that may be configured to execute object recognition and Augmented Reality (AR) functionality, in accordance with specific embodiments of the present invention. A “mobile device” 10 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The mobile device 10 may generally include a processor 11 communicably coupled to such devices as a memory 12, user output devices 22, user input devices 28, a network interface 34, a power source 32, a clock or other timer 30, an image capture device 44, a positioning system device 50 (e.g., a Global Positioning System (GPS) device), one or more integrated circuits 46, etc.

In some embodiments, the mobile device and/or the server access one or more databases or data stores (not shown in FIG. 1) to search for and/or retrieve information related to the object and/or marker. In some embodiments, the mobile device and/or the server access one or more data stores local to the mobile device and/or server and in other embodiments, the mobile device and/or server access data stores remote to the mobile device and/or server. In some embodiments, the mobile device and/or server access both a memory and/or data store local to the mobile device and/or server as well as a data store remote from the mobile device and/or server

The processor 11, and other processors described herein, may generally include circuitry for implementing communication and/or logic functions of the mobile device 10. For example, the processor 11 may include a digital signal processor device, a microprocessor device, and various analog to digital converters, digital to analog converters, and/or other support circuits. Control and signal processing functions of the mobile device 10 may be allocated between these devices according to their respective capabilities. The processor 11 thus may also include the functionality to encode and interleave messages and data prior to modulation and transmission. The processor 11 may additionally include an internal data modem. Further, the processor 11 may include functionality to operate one or more software programs or applications, which may be stored in the memory 12. For example, the processor 11 may be capable of operating a connectivity program, such as a web browser application 16. The web browser application 16 may then allow the mobile device 10 to transmit and receive web content, such as, for example, location-based content and/or other web page content, according to a Wireless Application Protocol (WAP), Hypertext Transfer Protocol (HTTP), and/or the like.

The processor 11 may also be capable of operating applications, such as an object recognition application 14. The object recognition application 14 may be downloaded from a server and stored in the memory 12 of the mobile device 10. Alternatively, the object recognition application 14 may be pre-installed and stored in a memory in the integrated circuit 46. In such an embodiment, the user may not need to download the object recognition application 14 from a server. In some embodiments, the processor 11 may also be capable of operating one or more applications, such as one or more applications functioning as an artificial intelligence (“AI”) engine. The processor 11 may recognize objects that it has identified in prior uses by way of the AI engine. In this way, the processor 11 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other modules or applications described herein to perform the various steps of the methods discussed. For example, in some embodiments, the AI engine recognizes an object that has been recognized before and stored by the AI engine. The AI engine may then communicate to another application or module of the mobile device and/or server, an indication that the object may be the same object previously recognized. In this regard, the AI engine may provide a baseline or starting point from which to determine the nature of the object. In other embodiments, the AI engine's recognition of an object is accepted as the final recognition of the object.

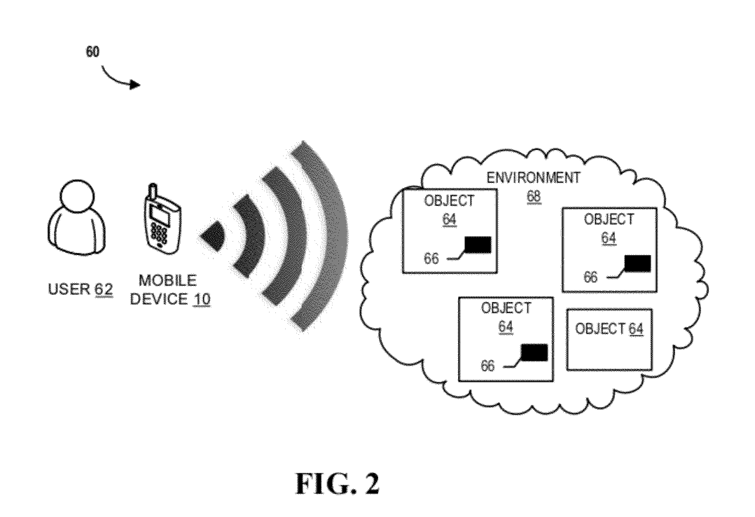

The integrated circuit 46 may include the necessary circuitry to provide the object recognition functionality to the mobile device 10. Generally, the integrated circuit 46 will include data storage 48 which may include data associated with the objects within a video stream that the object recognition application 14 identifies as having a certain marker(s) (discussed in relation to FIG. 2). The integrated circuit 46 and/or data storage 48 may be an integrated circuit, a microprocessor, a system-on-a-integrated circuit, a microcontroller, or the like. As discussed above, in one embodiment, the integrated circuit 46 may provide the functionality to the mobile device 10.

Of note, while FIG. 1 illustrates the integrated circuit 46 as a separate and distinct element within the mobile device 10, it will be apparent to those skilled in the art that the object recognition functionality of integrated circuit 46 may be incorporated within other elements in the mobile device 10. For instance, the functionality of the integrated circuit 46 may be incorporated within the mobile device memory 12 and/or processor 11. In a particular embodiment, the functionality of the integrated circuit 46 is incorporated in an element within the mobile device 10 that provides object recognition capabilities to the mobile device 10. Still further, the integrated circuit 46 functionality may be included in a removable storage device such as an SD card or the like.

The processor 11 may be configured to use the network interface 34 to communicate with one or more other devices on a network. In this regard, the network interface 34 may include an antenna 42 operatively coupled to a transmitter 40 and a receiver 36 (together a “transceiver”). The processor 11 may be configured to provide signals to and receive signals from the transmitter 40 and receiver 36, respectively. The signals may include signaling information in accordance with the air interface standard of the applicable cellular system of the wireless telephone network that may be part of the network. In this regard, the mobile device 10 may be configured to operate with one or more air interface standards, communication protocols, modulation types, and access types. By way of illustration, the mobile device 10 may be configured to operate in accordance with any of a number of first, second, third, and/or fourth-generation communication protocols and/or the like. For example, the mobile device 10 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 10 may also be configured to operate in accordance with non-cellular communication mechanisms, such as via a wireless local area network (WLAN) or other communication/data networks.

The network interface 34 may also include an object recognition interface 38 in order to allow a user to execute some or all of the above-described processes with respect to the object recognition application 14 and/or the integrated circuit 46. The object recognition interface 38 may have access to the hardware, e.g., the transceiver, and software previously described with respect to the network interface 34. Furthermore, the object recognition interface 38 may have the ability to connect to and communicate with an external data storage on a separate system within the network as a means of recognizing the object(s) in the video stream.

As described above, the mobile device 100 may have a user interface that includes user output devices 22 and/or user input devices 28. The user output devices 22 may include a display 24 (e.g., a liquid crystal display (LCD) or the like) and a speaker 26 or other audio device, which are operatively coupled to the processor 11. The user input devices 28, which may allow the mobile device 10 to receive data from a user, may include any of a number of devices allowing the mobile device 10 to receive data from a user, such as a keypad, keyboard, touch-screen, touchpad, microphone, mouse, joystick, other pointer device, button, soft key, and/or other input device(s).

The mobile device 10 may further include a power source 32. Generally, the power source 32 is a device that supplies electrical energy to an electrical load. In one embodiment, power source 32 may convert a form of energy such as solar energy, chemical energy, mechanical energy, etc. to electrical energy. Generally, the power source 32 in a mobile device 10 may be a battery, such as a lithium battery, a nickel-metal hydride battery, or the like, that is used for powering various circuits, e.g., the transceiver circuit, and other devices that are used to operate the mobile device 10. Alternatively, the power source 32 may be a power adapter that can connect a power supply from a power outlet to the mobile device 10. In such embodiments, a power adapter may be classified as a power source “in” the mobile device.

The mobile device 10 may also include a memory 12 operatively coupled to the processor 11. As used herein, memory may include any computer readable medium configured to store data, code, or other information. The memory 12 may include volatile memory, such as volatile Random Access Memory (RAM) including a cache area for the temporary storage of data. The memory 12 may also include non-volatile memory, which can be embedded and/or may be removable. The non-volatile memory may additionally or alternatively include an electrically erasable programmable read-only memory (EEPROM), flash memory or the like.

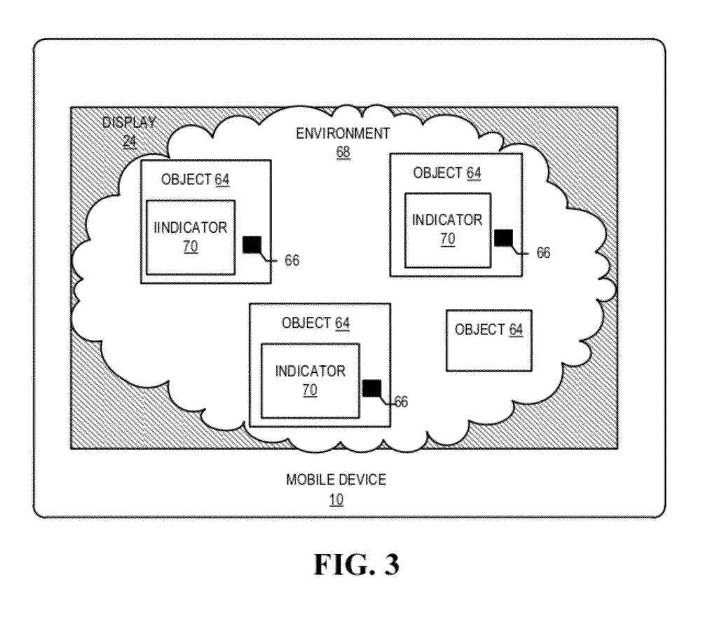

The memory 12 may store any of a number of applications or programs which comprise computer-executable instructions/code executed by the processor 11 to implement the functions of the mobile device 10 described herein. For example, the memory 12 may include such applications as an object recognition application 14, an augmented reality (AR) presentation application 17 (described infra. in relation to FIG. 3), a web browser application 16, a Short Message Service (SMS) application 18, an electronic mail (i.e., email) application 20, etc.

Referring to FIG. 2, a block diagram illustrating an object recognition experience 60 in which a user 62 utilizes a mobile device 10 to capture a video stream that includes an environment 68 is shown. As denoted earlier, the mobile device 10 may be any mobile communication device. The mobile device 10 has the capability of capturing a video stream of the surrounding environment 68. The video capture may be by any means known in the art. In one particular embodiment, the mobile device 10 is a mobile telephone equipped with an image capture device 44 capable of video capture.

The environment 68 contains a number of objects 64. Some of such objects 64 may include a marker 66 identifiable to an object recognition application that is either executed on the mobile device 10 or within the wireless network. A marker 66 may be any type of marker that is a distinguishing feature that can be interpreted by the object recognition application to identify specific objects 64. For instance, a marker 66 may be alpha-numeric characters, symbols, logos, shapes, ratio of size of one feature to another feature, a product identifying code such as a bar code, electromagnetic radiation such as radio waves (e.g., radio frequency identification (RFID)), architectural features, color, etc. In some embodiments, the marker 66 may be audio and the mobile device 10 may be capable of utilizing audio recognition to identify words or unique sounds broadcast. The marker 66 may be any size, shape, etc. Indeed, in some embodiments, the marker 66 may be very small relative to the object 64 such as the alpha-numeric characters that identify the name or model of an object 64, whereas, in other embodiments, the marker 66 is the entire object 64 such as the unique shape, size, structure, etc.

In some embodiments, the marker 66 is not actually a physical marker located on or being broadcast by the object 64. For instance, the marker 66 may be some type of identifiable feature that is an indication that the object 64 is nearby. In some embodiments, the marker 66 for an object 64 may actually be the marker 66 for a different object 64. For example, the mobile device 10 may recognize a particular building as being “Building A.” Data stored in the data storage 48 may indicate that “Building B” is located directly to the east and next to “Building A.” Thus, markers 66 for an object 64 that are not located on or being broadcast by the object 64 are generally based on fixed facts about the object 64 (e.g., “Building B” is next to “Building A”). However, it is not a requirement that such a marker 66 be such a fixed fact. The marker 66 may be anything that enables the mobile device 10 and associated applications to interpret to a desired confidence level what the object is. For another example, the mobile device 10, object recognition application 14 and/or AR presentation application 17 may be used to identify a particular person as a first character from a popular show, and thereafter utilize the information that the first character is nearby features of other characters to interpret that a second character, a third character, etc. are nearby, whereas without the identification of the first character, the features of the second and third characters may not have been used to identify the second and third characters. This example may also be applied to objects outside of people.

The marker 66 may also be, or include, social network data, such as data retrieved or communicated from the Internet, such as tweets, blog posts, social networking site posts, various types of messages and/or the like. In other embodiments, the marker 66 is provided in addition to social network data as mentioned above. For example, the mobile device 10 may capture a video stream and/or one or more still shots of a large gathering of people. In this example, as above, one or more people dressed as characters in costumes may be present at a specified location. The mobile device 10, object recognition application 14, and/or the AR presentation application 17 may identify several social network indicators, such as posts, blogs, tweets, messages, and/or the like indicating the presence of one or more of the characters at the specified location. In this way, the mobile device 10 and associated applications may communicate information regarding the social media communications to the user and/or use the information regarding the social media communications in conjunction with other methods of object recognition. For example, the mobile device 10 object recognition application 14, and/or the AR presentation application 17 performing recognition of the characters at the specified location may confirm that the characters being identified are in fact the correct characters based on the retrieved social media communications. This example may also be applied objects outside of people.

In some embodiments, the mobile device and/or server access one or more other servers, social media networks, applications and/or the like in order to retrieve and/or search for information useful in performing an object recognition. In some embodiments, the mobile device and/or server accesses another application by way of an application programming interface or API. In this regard, the mobile device and/or server may quickly search and/or retrieve information from the other program without requiring additional authentication steps or other gateway steps.

While FIG. 2 illustrates that the objects 64 with markers 66 only include a single marker 66, it will be appreciated that the object 64 may have any number of markers 66 with each equally capable of identifying the object 66. Similarly, multiple markers 66 may be identified by the mobile device 10 and associated applications such that the combination of the markers 66 may be utilized to identify the object 66. For example, the mobile device 10 may utilize facial recognition markers 66 to identify a person and/or utilize a separate marker 66, such as the clothes the person is wearing to confirm the identification to the desired confidence level that the person is in fact the person the mobile device identified. For example, the facial recognition may identify a person as a famous athlete, and thereafter utilize the uniform the person is wearing to confirm that it is in fact the famous athlete.

In some embodiments, a marker 66 may be the location of the object 64. In such embodiments, the mobile device 10 may utilize Global Positioning System (GPS) hardware and/or software or some other location determining mechanism to determine the location of the user 62 and/or object 64. As noted above, a location-based marker 66 could be utilized in conjunction with other non-location-based markers 66 identifiable and recognized by the mobile device 10 to identify the object 64. However, in some embodiments, a location-based marker may be the only marker 66. For instance, in such embodiments, the mobile device 10 may utilize GPS software to determine the location of the user 62 and a compass device or software to determine what direction the mobile device 10 is facing in order to identify the object 64. In still further embodiments, the mobile device 10 does not utilize any GPS data in the identification. In such embodiments, markers 66 utilized to identify the object 64 are not location-based.

FIG. 3 illustrates a mobile device 10, specifically the display 24 of the mobile 10, wherein the device 10 has executed an object recognition application 14 and an AR presentation application 17 to present within the display 24 indications of recognized objects within the live video stream (i.e., surrounding environment 68). The mobile device 10 is configured to rely on markers 66 to identify objects 64 that are associated with product offers, products with extended warranties, new products and the like, and indicate to the user 62 the identified objects 64 by displaying an indicator 70 on the mobile device display 130 in conjunction with display of the live video stream. As illustrated, if an object 64 does not have any markers 66 (or at least enough markers 66 to yield object identification), the object 64 will be displayed without an associated indicator 70.

The object recognition application 14 may use any type of means in order to identify desired objects 64. For instance, the object recognition application 14 may utilize one or more pattern recognition algorithms to analyze objects in the environment 68 and compare with markers 66 in data storage 48 which may be contained within the mobile device 10 (such as within integrated circuit 46) or externally on a separate system accessible via the connected network. For example, the pattern recognition algorithms may include decision trees, logistic regression, Bayes classifiers, support vector machines, kernel estimation, perceptrons, clustering algorithms, regression algorithms, categorical sequence labeling algorithms, real-valued sequence labeling algorithms, parsing algorithms, general algorithms for predicting arbitrarily-structured labels such as Bayesian networks and Markov random fields, ensemble learning algorithms such as bootstrap aggregating, boosting, ensemble averaging, combinations thereof, and the like.

Upon identifying an object 64 within the real-time video stream, the AR presentation application 17 is configured to superimpose an indicator 70 on the mobile device display 24. The indicator 70 is generally a graphical representation that highlights or outlines the object 64 and may be activatable (i.e., include an embedded link), such that the user 62 may “select” the indicator 70 and retrieve information related to the identified object. The information may include any desired information associated with the selected object and may range from basic information to greatly detailed information. In some embodiments, the indicator 70 may provide the user 62 with an internet hyperlink to further information on the object 64. The information may include, for example, all types of media, such as text, images, clipart, video clips, movies, or any other type of information desired. In yet other embodiments, the indicator 70 information related to the identified object may be visualized by the user 62 without “selecting” the indicator 70.

In embodiments in which the indicator 70 provides an interactive tab to the user 62, the user 62 may select the indicator 70 by any conventional means, e.g., keystroke, touch, voice command or the like, for interaction with the mobile device 10. For instance, in some embodiments, the user 62 may utilize an input device 28 such as a keyboard to highlight and select the indicator 70 in order to retrieve the information. In a particular embodiment, the mobile device display 24 includes a touch screen that the user may employ to select the indicator 70 utilizing the user's finger, a stylus, or the like.

In some embodiments, the indicator 70 is not be interactive and simply provides information to the user 62 by superimposing the indicator 70 onto the display 24. For example, in some instances it may be beneficial for the AR presentation application 17 to merely identify an object 64, e.g., just identify the object's name/title, give brief information about the object, etc., rather than provide extensive detail that requires interaction with the indicator 70. The AR presentation application 17 is capable of being tailored to a user's desired preferences.

Furthermore, the indicator 70 may be displayed at any size on the mobile device display 24. The indicator 70 may be small enough that it is positioned on or next to the object 64 being identified such that the object 64 remains discernable behind the indicator 70. Additionally, the indicator 70 may be semi-transparent or an outline of the object 64, such that the object 64 remains discernable behind or enclosed by the indicator 70. In other embodiments, the indicator 70 may be large enough to completely cover the object 64 portrayed on the display 24. Indeed, in some embodiments, the indicator 70 may cover a majority or the entirety of the mobile device display 24.

The user 62 may opt to execute the object recognition application 14 and AR presentation application 17 at any desired moment and begin video capture and analysis. However, in some embodiments, the object recognition application 14 and AR presentation application 17 includes an “always on” feature in which the mobile device 10 is continuously capturing video and analyzing the objects 64 within the video stream. In such embodiments, the object recognition application 14 may be configured to alert the user 62 that a particular object 64 has been identified. The user 62 may set any number of user preferences to tailor the object recognition and AR presentation experience to their needs. For instance, the user 62 may opt to only be alerted if a certain particular object 64 is identified. Additionally, it will be appreciated that the “always on” feature in which video is continuously captured may consume the mobile device power source 32 more quickly. Thus, in some embodiments, the “always on” feature may disengage if a determined event occurs such as low power source 32, low levels of light for an extended period of time (e.g., such as if the mobile device 10 is in a user's pocket obstructing a clear view of the environment 68 from the mobile device 10), if the mobile device 10 remains stationary (thus receiving the same video stream) for an extended period of time, the user sets a certain time of day to disengage, etc. Conversely, if the “always on” feature is disengaged due to the occurrence of such an event, the user 62 may opt for the “always on” feature to re-engage after the duration of the disengaging event (e.g., power source 32 is re-charged, light levels are increased, etc.).

In some embodiments, the user 62 may identify objects 64 that the object recognition application 14 does not identify and add it to the data storage 48 with desired information in order to be identified and/or displayed in the future. For instance, the user 62 may select an unidentified object 64 and enter a name/title and/or any other desired information for the unidentified object 64. In such embodiments, the object recognition application 14 may detect/record certain markers 66 about the object so that the pattern recognition algorithm(s) (or other identification means) may detect the object 64 in the future. Furthermore, in cases where the object information is within the data storage 48, but the object recognition application 14 fails to identify the object 64 (e.g., one or more identifying characteristics or markers 66 of the object has changed since it was added to the data storage 48 or the marker 66 simply was not identified), the user 62 may select the object 64 and associate it with an object 64 already stored in the data storage 48. In such cases, the object recognition application 14 may be capable of updating the markers 66 for the object 64 in order to identify the object in future video streams.

In addition, in some embodiments, the user 62 may opt to edit the information or add to the information provided by the indicator 70. For instance, the user 62 may opt to include user-specific information about a certain object 64 such that the information may be displayed upon a future identification of the object 64. Conversely, in some embodiments, the user may opt to delete or hide an object 64 from being identified and an indicator 70 associated therewith being displayed on the mobile device display 24.

Furthermore, in some instances, an object 64 may include one or more markers 66 identified by the object recognition application 14 that leads the object recognition application 14 to associate an object with more than one objects in the data storage 48. In such instances, the user 62 may be presented with multiple candidate identifications and may opt to choose the appropriate identification or input a different identification. The multiple candidates may be presented to the user 62 by any means. For instance, in one embodiment, the candidates are presented to the user 62 as a list wherein the “strongest” candidate is listed first based on reliability of the identification. Upon input by the user 62 identifying the object 64, the object recognition application 14 may “learn” from the input and store additional markers 66 in order to avoid multiple identification candidates for the same object 64 in future identifications.

Additionally, the object recognition application 14 may utilize other metrics for identification than identification algorithms. For instance, the object recognition application 14 may utilize the user's location, time of day, season, weather, speed of location changes (e.g., walking versus traveling), “busyness” (e.g., how many objects are in motion versus stationary in the video stream), as well any number of other conceivable factors in determining the identification of objects 64. Moreover, the user 62 may input preferences or other metrics for which the object recognition application 14 may utilize to narrow results of identified objects 64.

In some embodiments, the AR presentation application 17 may have the ability to gather and report user interactions with displayed indicators 70. The data elements gathered and reported may include, but are not limited to, number of offer impressions; time spent “viewing” an offer, product, object or business; number of offers investigated via a selection; number of offers loaded to an electronic wallet and the like. Such user interactions may be reported to any type of entity desired. In one particular embodiment, the user interactions may be reported to a financial institution and the information reported may include customer financial behavior, purchase power/transaction history, and the like.

In various embodiments, information associated with or related to one or more objects that is retrieved for presentation to a user via the mobile device may be permanently or semi-permanently associated with the object. In other words, the object may be “tagged” with the information. In some embodiments, a location pointer is associated with an object after information is retrieved regarding the object. In this regard, subsequent mobile devices capturing the object for recognition may retrieve the associated information, tags and/or pointers in order to more quickly retrieve information regarding the object. In some embodiments, the mobile device provides the user an opportunity to post messages, links to information or the like and associate such postings with the object. Subsequent users may then be presenting such postings when their mobile devices capture and recognize an object. In some embodiments, the information gathered through the recognition and information retrieval process may be posted by the user in association with the object. Such tags and/or postings may be stored in a predetermined memory and/or database for ease of searching and retrieval.

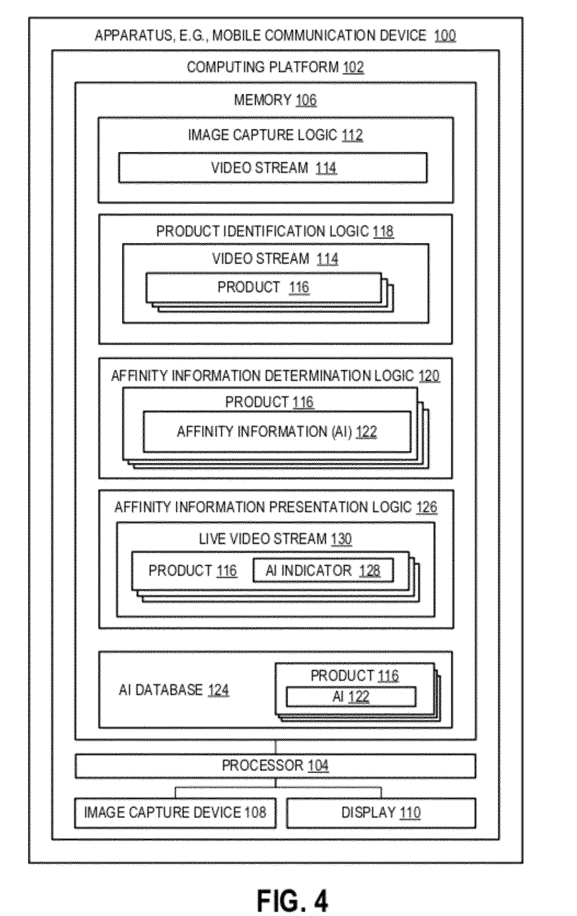

Referring to FIG. 4, an apparatus 100 configured for presenting affinity information (AI) in a live video stream, in accordance with embodiments of the present invention. The apparatus includes a computing platform 102 having a processor 104 and a memory 106 in communication with the processor. Additionally, apparatus 100 includes image capture device 108 and display 110 both in communication with processor 104.

It should be noted that the apparatus 100 may include more than one computing device. For example, apparatus 100 may include a mobile communication device and a network device, which operate in unison to present AI in a live video stream displayed on a display of the mobile communication device. Thus, the logic shown and described in apparatus 100 may reside and be executed on a mobile communication device or a network device that is in wireless communication with the mobile communication device. A mobile communication device may be a mobile cellular telephone, such as a smart phone or the like, a Personal Data Assistant (PDA) a tablet computing device, a laptop device or any other computing device having an image capture device 108 and a display 110. It should be noted that while many embodiments of the mobile communication device are personal and/or handheld devices, in other embodiments of the invention a mobile communication device may be permanently or temporarily located within a moving vehicle, such as an automobile or the like.

The memory 106 of apparatus 100 includes image capture logic 112 that is in communication with image capture device 108 and configured to capture a video stream 114. It should be noted that the video stream 114 may be captured from various different environments. For example, the video stream 114 may be captured while shopping in a retail location, such as an aisle of a grocery store, department store, home improvement store, physician's office, pharmacy or the like. In addition, the video stream 114 may be captured in the user residence, such as video of the contents of a medicine cabinet, pantry, cupboard, storage area, a refrigerator or the like. In other embodiments, the video stream 114 may be captured while watching media, such as television, Internet or the like, reading media, such as via the Internet, a billboard advertisement, magazine, newspaper or the like.

In some embodiments, the information provided by the real-time video stream may be compared to data provided to the system through an API. In this way, the data may be stored in a separate API and be implemented by request from the mobile device and/or server.

The memory 106 of apparatus 100 additionally includes product identification logic 118 that is configured to identify one or more products 116 in the video stream 114. For purposes of this disclosure products 116 may include products, services and entities associated with products or services, such as business entities, manufacturers or the like. The product identification logic 118 may implement any known or future known identification mechanisms. For example, product identification logic may implement image recognition techniques based on characteristics, indicia (e.g., Optical Character Recognition (OCR) or the like), logos, shapes and the like associated with a product. In addition, in those embodiments in which the products or tags displayed in conjunction with the products include a visually readable code, such as Quick Response (QR) code, bar code or the like, the product identification logic 118 may be implemented to decipher the code to identify the product.

In other embodiments of the invention, the product identification logic 118 may identify the one or more products 116 based on the geographic location of the products or information communicated from the products. In such embodiments, the product identification logic 118 may be configured to identify products 116 by implementing geo-fencing techniques or any other spatial technique. In other such embodiments, the product identification logic 118 may be configured to sense and receive short range communication, such as via Near Field Communication (NFC), Radio Frequency Identification (RFID), Bluetooth® or the like, which includes identification of the products. Since product identification based on location and/or information communicated from the products does not rely on an image for identification, such identification may be lieu of or implemented in combination with visual identification techniques described above.

The memory 106 of apparatus 100 additionally includes affinity information (AI) determination logic 120 configured to determine if an identified product 116 currently has associated affinity information. The affinity information may include, in various embodiments, information corresponding to an affinity associated with the product. In some embodiments, the AI includes information related to an affinity with which the user is already associated as related to the product. Such information may include, for example, information related to the goal(s) and/or parameters of an affinity or an affinity group, the benefit to the affinity should the user purchase the product, the benefit to the affinity should the user purchase another product or should the user purchase the product in addition to one or more other products, and/or the like.

In some embodiments, the AI includes information regarding other products or retailers in the vicinity of the user currently offering products having affinity programs associated with them or discounts for purchases of certain products associated with affinity programs, and/or the like, thereby potentially making the product more attractive at their current location or other, competing location. Similarly, the AI may provide information regarding the percentage of the product purchase price that will be donated to the affinity should the user purchase the product, or in other embodiments, the AI may provide information regarding a matching contribution from the retailer or some other party, such as a party expressing a specific interest in the affinity and having established a relationship with the affinity, the retailer, the user or the like, that will be made to the affinity should the user purchase the product. In some embodiments, the mobile device provides the user an opportunity to purchase from the current retailer or another retailer. In some embodiments, once the user has chosen a product for purchase, the device automatically purchases the product, such as through an online transaction, from the current retailer or another retailer, either brick and mortar or online.

In some embodiments, the mobile device of the user recognizes that the user is viewing specific products, for example in a retail store, and presents one or more targeted offers regarding establishing a relationship between an affinity and the new products. For example, if the mobile captures recognition of a product, the mobile may communicate such information to a server, which compiles information regarding the user's interest in the product, and in some instances, information regarding others' interest in products. The server may then communicate that information to an affinity or an affinity project administrator or coordinator in order to propose establishing a new relationship regarding the affinity and the product. In some embodiments, the affinity to which the proposal is made is determined based on information retrieved and associated with the user's current affinity relationships and/or interests, such as information retrieved from the user's social network. In some embodiments, a preexisting affinity relationship of the user is targeted and it is proposed to the affinity and/or the affinity project coordinator that the new product(s) be targeted for association with the affinity.

Once the product has been purchased, in various embodiments, the mobile device provides the user with a communication regarding the results of the purchase. In some instances, the mobile device communicates to the user that the affinity has received $XXX.XX because the user purchased the product. In other embodiments, the mobile device provides a percentage of the purchase that was donated to the affinity. In some embodiments, the mobile device communicates to the user proof that the transfer of funds to the affinity has occurred, such as a financial institution receipt or the like. In some embodiments, the user has an affinity account that accumulates dollars, points or some other marker that may be compared to some predetermined or varying threshold such that once the threshold is achieved a donation is made to the affinity on behalf of the user. In this regard, transparency into the affinity account is provided to the user. In some embodiments, the AI includes information regarding the number of points or other marker necessary to attain before a donation, such as a donation for a specific dollar amount, is made to the affinity. The AI may also include information regarding a total number of dollars already donated to the affinity on behalf of the user or a social network of the user. In some such embodiments, the user works in collaboration with a social network or an affinity group in order to achieve particular goals with regard to the affinity. In this regard, the user's affinity group may receive periodic updates or other communications regarding the progress of the affinity group toward the common goal, such as reaching a predetermined number of points in order for a donation to be made to the affinity.

The AI may also include information regarding the user's purchase history, either of a particular product or corresponding to the user's purchases where the products were associated with one or more affinities as well as information regarding the user's purchases that were not associated with one or more affinities. In some embodiments, the AI may include information comparing the affinity-associated purchases with the non-affinity associated purchases. In some embodiments, the AI may also include one or more targeted offers to purchase certain products or visit certain retailers in an effort to improve, for example, a user's ratio of affinity-associated products purchased to non-affinity-associated products purchased. The AI may include information regarding whether the product was associated with any other affinities in the past or is slated to be associated with any other affinities in the future. In some embodiments, the AI includes information regarding whether any friends or members of a social network posted any information regarding the product and/or the affinity associated with the product. In some embodiments, the AI may include an avatar-based intelligent agent configured to evaluate the product for effect on one or more affinities or affinity groups and provide a recommendation for purchase of that product and/or other products based on the user's defined goals regarding the one or more affinities.

AI determination logic 120 is in communication with AI database 124 which stores AI 122 for products 116. The AI determination logic 120 may be configured by the user or by the entity providing for the AI program. For example, the user may configure the apparatus 100 such that only AI 122 of a certain type is determined, such as AI for a specific product, a specific brand of product, a specific provider/retailer of the product, a specific affinity, a specific affinity group, only the affinities “liked” or associated with one or more entities within the user's social network, or the like. In additional embodiments, the entity providing the AI program may configure the apparatus 100 such that only AI 122 from predetermined manufacturers, retailers, product suppliers, and the like are determined, such as manufacturers and/or retailers that are affiliated or otherwise have a relationship with the entity providing the AI program.

The memory 106 of apparatus 100 additionally includes AI presentation logic 126 that is configured to present one or more AI indicators 128, on a display of mobile communication device, each AI indicator 128 presented in a live video stream 130 proximate a location of the one or more products 116 determined to be associated with AI 122.

In some embodiments, the AI presentation logic 126 is configured for presenting the AI by itself. That is, the AI is presented in response to the user's selection of an indicator associated with an object or product, and is presented instead of the real-time video stream. In some embodiments, the AI presentation logic 126 is configured to present a website related to the AI, such as a website detailing the affinity program, such as, for example, including information regarding the entity to which a potential donation will be made, and the potential or predetermined perceived impact of the purchase of the product on the entity to which a donation will be made. In one example, the perceived impact may include that purchasing the product will provide a day's supply of food for needy child associated with the affinity entity. In various embodiments, for example, the AI presentation logic 126 is configured to access information related to the user's interests, such as the user's interest in the helping the homeless. Such information may be available from a variety of sources, such as from the user's social network application(s). The AI presentation logic, in some embodiments, is further configured to present to the user an indicator, such as a large red “X” overlaid on the real-time video stream representation of the product. Thus, the user is made aware of the fact that no affinity or, in some instances, no affinity with which the user has an affiliation, is associated with the product.

In various embodiments of the invention, the AI indicator 128 may be a graphical tag, highlighted area or an outline around the border of the product 116 as displayed in the live video stream 130. As discussed in the example above, a user of the mobile communication device may activate the AI indicator 128, through touch, mouse-pointer click, keypad, voice command or the like, to display further information regarding the AI 122 (e.g., additional resources for information, such as information regarding the affinity program, the affinity, an affinity group, and the like), download the AI to their mobile communication device for subsequent consideration during a purchasing decision or, for example, during consideration of the purchase of another product in a different location and/or initiate network communication with a website or the like for retrieving additional information and conducting a transaction to purchase the product 116.

In specific embodiments of the invention, the user of the mobile communication device may be actively “looking” for AI by positioning the image capture device 108 in front of products 116 so as to capture the video stream 114, subsequently identify the products, determine if any AI is associated with the products and present the AI indicators 128 in the live video stream 130 that the user is viewing. For example, the user positions the mobile device to scan the aisle of a pharmacy, grocery store, retail store, nursery, or the like. In some embodiments, the mobile device may be configured to recommend combining products within a particular store or within a specified time period in order for the user to achieve a goal and thereby effect a donation and/or accumulation of points or other markers toward the making of a donation. For example, the mobile device may recommend to a user that if the user purchases a gallon of a particular brand of milk as well as a box of a particular brand of cereal, then a donation will be made to one or more of the user's associated affinities. Relationships between the retailer and brand owner may be established to facilitate such opportunities.

In some embodiments, the invention, such as the mobile device and/or the server(s) have vision into one of more social network(s) of the user such that the system may access information regarding the affinities, affinity programs, affinity network and the like with which the user's social network members are affiliated or associated. In some such embodiments, the system presents targeted offers for the user to join the affinity, affinity program or network.

In other specific embodiments of the invention, the user may be passively “looking” for AI associated with products, such as when the apparatus 100 has been configured to search for user-specified AI or the like. In such a passive mode, the mobile communication device may be in a continuously-on mode and/or automatically turned on and off on a predetermined periodical schedule (i.e., intermittent mode). In the passive mode, determination and presentation of an offer may require that the user be prompted to notify the user of the AI associated with a product. The prompt may include communicating an alert to the user, such as an audio alert communicated from the mobile communication device, e.g., an audible alarm or the like, and/or a visual alert, e.g., display of a flashing light on the mobile communication device or the like.

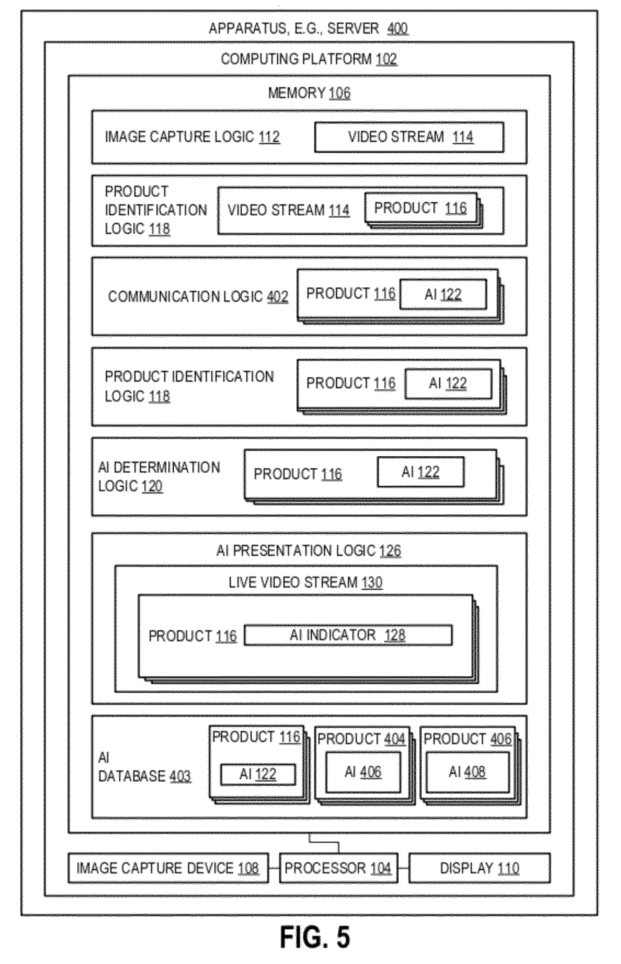

FIG. 5 is an additional block diagram regarding presenting AI in conjunction with a live video stream, in accordance with embodiments of the present invention. In addition to highlighting and describing further details of the invention, FIG. 5 provides for alternate embodiments of the invention. The apparatus 400 includes a computing platform 102 having at least one processor 104 and a memory 106 in communication with the processor. The apparatus, in various embodiments, may be a server or bank of servers or other computing devices remote from a mobile communication device and in communication with a mobile communication device over a network. Memory 106 may be resident on the apparatus 400 or at least a portion of memory 106 may be remote memory that is network accessible to the server and/or the mobile communication device, for example, at least a portion of memory 106 may reside on servers or the like as part of the offer providing entity's network. Memory 106 may comprise volatile and nonvolatile memory such as read-only and/or random-access memory (RAM and ROM), EPROM, EEPROM, flash cards, or any memory common to computing platforms. Further, memory 106 may include one or more flash memory cells, or may be any secondary or tertiary storage device, such as magnetic media, optical media, tape, or soft or hard disk.

Processor 104 may be an application-specific integrated circuit (“ASIC”), or other integrated circuit set, processor, logic circuit, or other data processing device. Processor 104 or other processor such as an Application Specific Integrated Circuit (ASIC) may execute an application programming interface (“API”) layer (not shown in FIG. 5) that interfaces with any resident programs or modules, such as product identification logic 118, AI determination logic 120, and AI presentation logic 130 stored in the memory 106 of the apparatus 100 and/or apparatus 400.

Processor 104 may include various processing subsystems (not shown in FIG. 5) embodied in hardware, firmware, software, and combinations thereof, that enable the functionality of apparatus 100 and/or apparatus 400 and the operability of the apparatus 100 and/or apparatus 400 on a network. For example, processing subsystems allow for initiating and maintaining communications, and exchanging data, with other networked devices. For the disclosed embodiments, processing subsystems of apparatus 100 and/or apparatus 400 may include any subsystem used in conjunction with applications, modules, components and routines described herein.

As previously discussed, the memory 106 of apparatus 100 includes image capture logic 112 that is in communication with image capture device 108 and configured to capture a video stream 114. Additionally, memory 106 includes product identification logic 118 that is configured to identify one or more products 116 in the video stream 114. For example, product identification logic 118 may implement image recognition techniques based on characteristics, indicia (e.g., Optical Character Recognition (OCR) or the like), logos, shapes and the like associated with a product. In addition, in those embodiments in which the products or tags displayed in conjunction with the products include a visually readable code, such as Quick Response (QR) code, bar code or the like, the product identification logic 118 may be implemented to decipher the code to identify the product.

The memory 106 of apparatus 100 additionally includes AI determination logic 120 configured to determine if an identified product 116 has associated AI 122. Thus, AI determination logic 120 is in communication with database 403 which stores AI 122 for products 116 and/or new products 404 and 406. New products 404 and 406 are associated, respectively, with AI 406 and AI 408. In various embodiments, the new products 404 and 406 are products that are presented as alternatives to products associated with AI that is in some way less attractive to the user, such as AI indicating an associated with an affinity for which the user has explicitly indicated a dislike.

Additionally, in specific embodiments of the invention, memory 106 of apparatus 400 includes communication logic 402 that is configured to create and communicate instructions from apparatus 400 (e.g, server) to apparatus 100 (e.g., mobile communication device) in order to initiate display of a presentation of the AI in conjunction with the real-time video stream or other type of display, such as merely displaying the AI. Thus, communication logic 402 is in communication with database 403, which stores AI 122, AI 406 and/or AI 408 for designated products 116, 404 and/or 408, respectively.

As previously discussed in relation to FIG. 4, the memory 106 of apparatus 100 additionally includes AI presentation logic 126 that is configured to present one or more AI indicators 128 on a display of mobile communication device. Each AI indicator 128 is presented in a live video stream 130 proximate a location of the one or more products 406 and/or 408 determined to be associated with a product 116.

In one embodiment of the invention, the AI indicators 128 and/or any other indicators which indicate a feature related to the AI associated with the product may be displayed separately. In such embodiments, the user of the mobile communication device may switch between modes to display the information which they are interested in. For example, a first mode may provide for display of AI indicators 128, a second mode may provide for display of AI indicators corresponding to a different type of product or class of product, and a third mode may provide for display of other designated product-related indicators and so on. Switching between modes may be configured to occur by any configurable means, such as key activation, touch screen activation, voice command or the like.

In other related embodiments of the invention, two or more AI indicators and/or any other indicators may be displayed in unison, such that indicators are graphically distinct, such as different colors, highlights, etc and may be configured to overlay one another. As previously noted, in one embodiment of the invention the AI indicators may be a graphical tag, highlighted area, such as specific color or pattern highlighting, or an outline around the border of the product 116 as displayed in the live video stream 130. The user of the mobile communication device may activate the indicators through touch, mouse-pointer click, keypad, voice command or the like, to display further information regarding the AI 122.

In one specific embodiment of the invention, the AI indicator 128 may be configured as a dotted-line surrounding the border of the associated product 116. The user may activate the AI indicator 128, such as by touching the display in the area of the product, providing the requisite key stroke or voice command or the like. Upon activation, the AI 122 is automatically downloaded to an AI database, which is sometimes referred to as electronic AI.

In other embodiments of the invention, other indicators, such as a solid line surrounding the border of an associated product 404 and/or 408 may be implemented to indicate that the AI already exists in the user's mobile device stored AI. In still further embodiments of the invention, other indicators may be implemented to communicate other information about the AI. For example, other indicators may indicate that AI is out of date and the user should seek out updated AI from another source. In some embodiments, information regarding additional sources is presented to the user, such as, for example, information regarding one or more websites hosting additional information, such as live video chat with an affinity representative, peer, buddy, social network member or the like for information, consulting and/or positive feedback, and/or contact information regarding one or more people capable of providing updated AI. In some embodiments, the contact information corresponds to those people within a predetermined physical radius of the user and in other embodiments the people are already associated with the user, such as in an affinity group or in a social network. In one specific embodiment of the invention, a blinking AI indicator 128 may indicate that the AI has some characteristic particularly useful to the user, such as the product is associated with two or more affinities with which the user has demonstrated an interest or relationship.

In other embodiments, of the invention, activation of the AI indicator 128 may provide for the mobile communication device to initiate communication with a network entity, such as a web site or the like, configured for purchasing the product 116, or providing additional information related to the product 116.

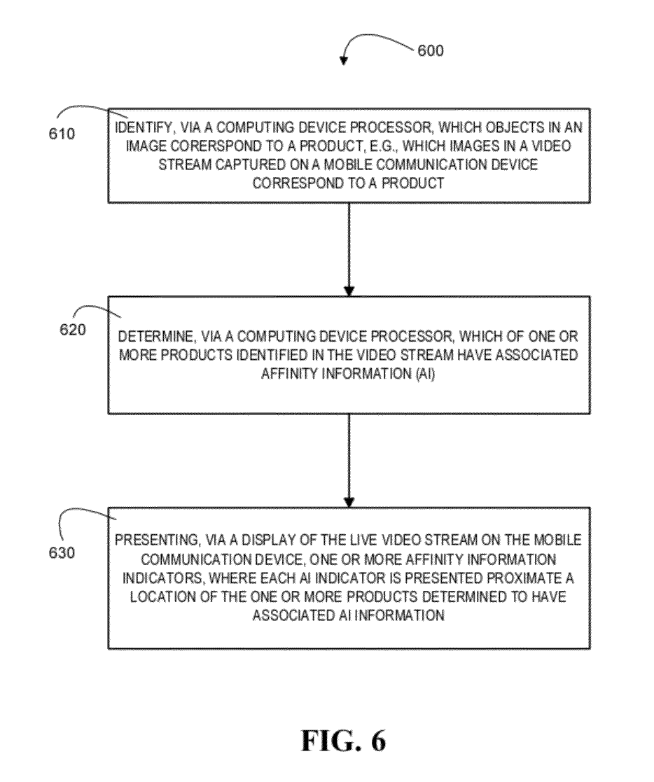

Referring to FIG. 6 a flow diagram is depicted of a method 600 for providing affinity information.

At Event 610, images in a video stream captured on a mobile communication device are identified as corresponding to products offered for sale. Capturing of the video stream may include, for example, a user moving about an aisle within a pharmacy, grocery store or other retailer while positioning the mobile communication device to view, and capture the video stream of, the products on the shelves in the aisle. In another embodiment of the invention, a user may capture a video stream within their residence, such as positioning the mobile communication device to view, and capture the video stream of, products within their cupboard/pantry or their refrigerator/freezer or the like, specific products/appliances within the residence which may need replacement or duplication, or products shown in a television commercial, online video, online advertisement, Youtube video or the like. In such situations, the mobile communication device may be configured to provide AI indicating other products, updated products, or replacement products having associated affinities, such as one or more products having associated affinities for which the user has demonstrated an interest and/or relationship.

Identifying which images from the video stream are associated with products (including services) may include analyzing the real-time video stream for objects, logos, artwork or other product-indicating features, referred to herein as markers, to identify the images as products. As previously noted, the images may also be identified as products based on coded information, such as QR code, bar code or the like, affixed to proximate to the product. In addition, product identification may utilize Optical Character recognition (OCR), geo-fencing/position location, short range communication (e.g., NFC, RFID or the like) in addition to, or in lieu of, identification of the products based on the images captured on the mobile communication device.

At Event 620, one or more of the identified products are determined to currently be associated with AI. The AI may include, but is not limited to, information regarding the affinity program, the entity benefitting from the affinity program, or the like. Determination of which products have associated AI may be implemented by comparing the identified products to database listing of products currently associated with AI. The stored listing of product AI may be specific to the retail location at which the real-time video stream is being captured or, in other embodiments, the listing or listings of product AI may be specific to retail/merchant locations (physical or online) at which the user of the mobile communication typically shops or from competing retailers/merchants at which the user does not typically shop or a combination of both. In other embodiments, the listing or listings of product AI may be associated with one or more third-party product programs, such as a financial institution AI program or the like. Thus, in those embodiments in which the AI is not tied to the location of the real-time video stream, such as residential video stream or the like, the AI may be irrespective of which retailer/merchant the user typically uses and/or prefers. It should be noted that in certain embodiments, user configuration may dictate which types of AI the user desires and, thus, which databases are accessed for searching/retrieving the AI or which filters are implemented within the databases for determining associated AI.

At Event 630, one or more indicators are presented on the display of the mobile communication device in conjunction with a live video stream. Each of the indicators is presented proximate to a location of a corresponding product determined to currently have associated AI. As previously noted, the indicator may take various forms, such as display of a tag, a highlighted area, a hot-spot or the like. In specific embodiments, the indicator is a selectable indicator, such that a user may select (e.g., click-on, hover-over, touch the display, provide a voice command or the like) the indicator to provide display of specifics related to the AI, downloading the AI to an electronic folder, called an electronic AI or accessing a network entity, such as a web site, for purchasing the product. In other embodiments, the indicator itself may provide the AI or a portion of the AI.

In other specific embodiments, the indicator may indicate the availability of current AI, such as a specific color-code, shading or outlining of the product (e.g., dotted-line outlining the product). The user of the mobile communication device may select (e.g., click-on, hover-over, touch the display, provide a voice command or the like) the indicator to add some or all the AI to an electronic storage area, referred to herein as an electronic AI. AI that has previously been added to the electronic AI but has yet to have been reviewed by the user may provide for a different visual indicator than AI that have yet to be added to the electronic AI. For example, AI that has previously been added may be shaded differently than AI previously added to the electronic AI or may have a solid-line outlining the product. Other visual indicators may indicate other features of the AI, such as expirations of the associated between the affinity and the product, whether the product fits within the user's predetermined affinity contribution goals, or the like.

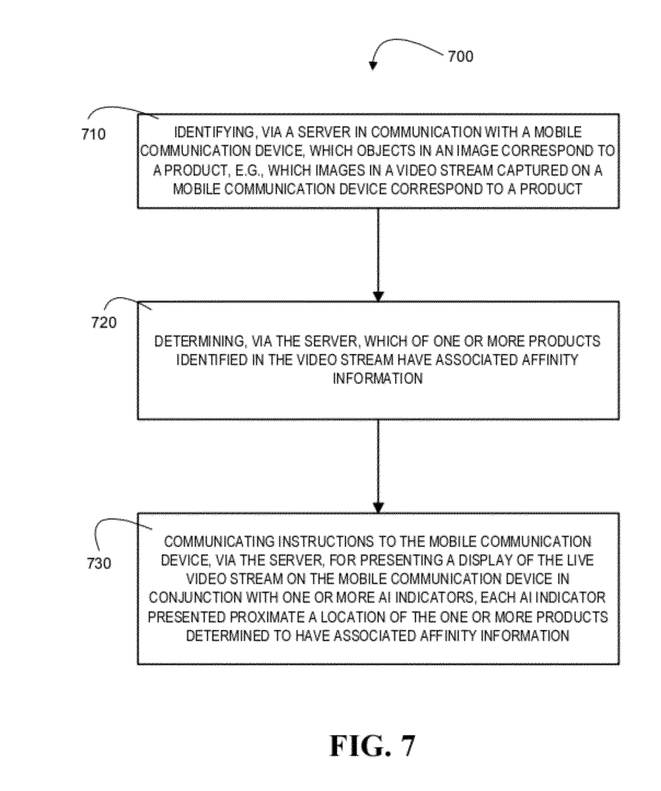

Referring to FIG. 7 a flow diagram is depicted of another method 700 for presenting providing affinity information.

At Event 710, a server in communication with a mobile communication device identifies any images in a video stream captured on a mobile communication device corresponding to a product. At Event 720, the server determines which of one or more products identified in the video stream have associated AI. At Event 730, the server communicates instructions to the mobile communication device for presenting a display of the live video stream on the mobile communication device in conjunction with one or more AI indicators. In some embodiments, each AI indicator is presented proximate a location of the one or more products determined to have associated AI.

In some embodiments, the user's social network, family or friends' associated affinities, that is, the affinities to which the members of the social network are affiliated and/or those in which the members are interested are addressed by the invention. For example, the user's immediate family provides information regarding the affinities in which those individuals are interested. Such information is stored on one or more memories and/or databases discussed above. The information is then used in conjunction with the real-time image analysis to determine whether and objects or products captured in the video stream meet the interests of one or more of the family members. For example, in some embodiments, the family members upload information regarding their affinity relationships, such as their ownership of a demand deposit account which is associated with an affinity. The father of the family, for example, while he is shopping at a grocery store is using his mobile device to identify products needed by the family. The mobile device captures images of various boxes of diapers and provides one or more indicators indicating which, if any, of the boxes of diapers are associated with affinities for which one or more family members have expressed an interest. Further, in conjunction with various embodiments of the invention, various other information may be provided via the mobile device to the user, such as, for example, coupon offers, offers for different levels of rewards in addition to affinity benefits and the like.

In yet other embodiments, the mobile device and/or server(s) may be provided a wish list from the user and/or an administrator of the system including predefined rules engines including instructions such that when a targeted offer, recognized product or other object matches the predefined rules the financial institution server may execute the purchase of and payment for the product, on behalf of the user.

In some embodiments, the user's interests are dynamically matched to interests identified in a social network. In some such embodiments, a new affinity relationship for the user is proposed to the user via the user's mobile device.

Thus, methods, systems, computer programs and the like have been disclosed that provide for using real-time video analysis, such as AR or the like to assist the user of mobile devices with commerce activities. Through the use real-time vision object recognition objects, logos, artwork, products, locations and other features that can be recognized in the real-time video stream can be matched to data associated with such to assist the user with commerce activity. The commerce activity may include, but is not limited to; conducting a transaction, providing information about a product/service, providing rewards based information, providing user-specific offers, or the like. In specific embodiments, the data that matched to the images in the real-time video stream in specific to financial institutions, such as customer financial behavior history, customer purchase power/transaction history and the like. In this regard, many of the embodiments herein disclosed leverage financial institution data, which is uniquely specific to financial institution, in providing information to mobile devices users in connection with real-time video stream analysis.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

The systems, methods, computer program products, etc. described herein, may be utilized or combined with any other suitable AR-related application. Non-limiting examples of other suitable AR-related applications include those described in the following U.S. Provisional Patent Applications, the entirety of each of which is incorporated herein by reference:

| U.S. | | |
|---|---|---|
| Provisional | | |
| Ser. No. | Filed On | Title |
| 61/450,213 | Mar. 8, 2011 | Real-Time Video Image Analysis |
| | | Applications for Commerce Activity |
| 61/478,409 | Apr. 22, 2011 | Presenting Offers on a Mobile |
| | | Communication Device |
| 61/478,412 | Apr. 22, 2011 | Real-Time Video Analysis for Reward |
| | | Offers |
| 61/478,394 | Apr. 22, 2011 | Real-Time Video Image Analysis for |
| | | Providing Targeted Offers |
| 61/478,399 | Apr. 22, 2011 | Real-Time Analysis Involving Real |
| | | Estate Listings |
| 61/478,402 | Apr. 22, 2011 | Real-Time Video Image Analysis for an |
| | | Appropriate Payment Account |
| 61/478,405 | Apr. 22, 2011 | Presenting Investment-Related |
| | | Information on a Mobile Communication |
| | | Device |
| 61/478,393 | Apr. 22, 2011 | Real-Time Image Analysis for Medical |
| | | Savings Plans |
| 61/478,397 | Apr. 22, 2011 | Providing Data Associated With |
| | | Relationships Between Individuals and |
| | | Images |
| 61/478,408 | Apr. 22, 2011 | Identifying Predetermined Objects in a |
| | | Video Stream Captured by a Mobile |
| | | Device |
| 61/478,400 | Apr. 22, 2011 | Real-Time Image Analysis for Providing |
| | | Health Related Information |
| 61/478,411 | Apr. 22, 2011 | Retrieving Product Information From |
| | | Embedded Sensors Via Mobile Device |
| | | Video Analysis |
| 61/478,403 | Apr. 22, 2011 | Providing Social Impact Information |
| | | Associated With Identified Products or |
| | | Businesses |
| 61/478,407 | Apr. 22, 2011 | Providing Information Associated With |
| | | an Identified Representation of an Object |
| 61/478,415 | Apr. 22, 2011 | Providing Location Identification of |
| | | Associated Individuals Based on |
| | | Identifying the Individuals in |
| | | Conjunction With a Live Video Stream |
| 61/478,419 | Apr. 22, 2011 | Vehicle Recognition |
| 61/478,417 | Apr. 22, 2011 | Collective Network of Augmented |
| | | Reality Users |
| 61/508,985 | Jul. 18, 2011 | Providing Information Regarding |
| | | Medical Conditions |
| 61/508,946 | Jul. 18, 2011 | Dynamically Identifying Individuals |
| | | From a Captured Image |
| 61/508,821 | Jul. 18, 2011 | Providing Information Regarding Sports |
| | | Movements |
| 61/508,850 | Jul. 18, 2011 | Assessing Environmental Characteristics |
| | | in a Video Stream Captured by a Mobile |
| | | Device |
| 61/508,966 | Jul. 18, 2011 | Real-Time Video Image Analysis for |
| | | Providing Virtual Landscaping |
| 61/508,969 | Jul. 18, 2011 | Real-Time Video Image Analysis for |
| | | Providing Virtual Interior Design |
| 61/508,971 | Jul. 18, 2011 | Real-Time Video Image Analysis for |
| | | Providing Deepening Customer Value |
| 61/508,764 | Jul. 18, 2011 | Conducting Financial Transactions Based |
| | | on Identification of Individuals in an |
| | | Augmented Reality Environment |
| 61/508,973 | Jul. 18, 2011 | Real-Time Video Image Analysis for |
| | | Providing Security |
| 61/508,976 | Jul. 18, 2011 | Providing Retail Shopping Assistance |
| 61/508,944 | Jul. 18, 2011 | Recognizing Financial Document Images |

What is claimed is:

1. A method for providing affinity information, the method comprising:
identifying, via a computing device processor, which objects in an image captured on a mobile communication device correspond to a product;
determining, via a computing device processor, which of one or more products identified in the image have associated affinity information; and
presenting, via a display of the live video stream on the mobile communication device, one or more affinity information indicators, each affinity information indicator presented proximate a location of the one or more products determined to have associated affinity information.

2. The method of claim 1, wherein identifying a product comprises identifying one or more images in a video stream captured on a mobile communication device that correspond to one or more products.

3. The method of claim 1, wherein identifying a product comprises identifying one or more objects in a still image captured on a mobile communication device that corresponds to one or more products.

4. The method of claim 1, wherein identifying a product comprises identifying one or more products based at least in part on global positioning system information associated with the mobile communication device or other information indicating a location of the mobile communication device.

5. An apparatus for providing affinity information, the apparatus comprising:
a computing platform having a processor, a memory in communication with the processor, and
image capture logic stored in the memory, executable by the processor and configured to capture an image, and
product identification logic stored in the memory, executable by the processor and configured to identify which objects in the image captured by a mobile communication device correspond to a product, and
affinity information logic stored in the memory, executable by the processor and configured to determine whether the identified product has associated affinity information; and
affinity information presentation logic stored in the memory, executable by the processor and configured to present, on a display of the mobile communication device, one or more affinity information indicators, each affinity information indicator presented proximate a location of the product determined to have associated affinity information.

6. The apparatus of claim 5, wherein the product identification logic is configured to identify one or more images in a video stream captured on a mobile communication device that correspond to one or more products.

7. The apparatus of claim 5, wherein the product identification logic is configured to identify one or more objects in a still image captured on a mobile communication device that corresponds to one or more products.

8. The apparatus of claim 5, wherein the product identification logic is configured to identify one or more products based at least in part on global positioning system information associated with the mobile communication device or other information indicating a location of the mobile communication device.

9. A computer program product comprising a non-transitory computer-readable medium comprising computer-executable instructions for providing affinity information, the instructions comprising:
instructions for identifying which objects in an image captured on a mobile communication device correspond to a product;
instructions for determining which of one or more products identified in the image have associated affinity information; and
instructions for presenting one or more affinity information indicators displayed on the mobile communication device, each affinity information indicator presented proximate a location of the one or more determined products.

10. The computer program product of claim 9, wherein identifying a product comprises identifying one or more images in a video stream captured on a mobile communication device that correspond to one or more products.

11. The computer program product of claim 9, wherein identifying a product comprises identifying one or more objects in a still image captured on a mobile communication device that corresponds to one or more products.

12. The computer program product of claim 9, wherein identifying a product comprises identifying one or more products based at least in part on global positioning system information associated with the mobile communication device or other information indicating a location of the mobile communication device.

13. A method for providing affinity information, the method comprising:
identifying, via a server in communication with a mobile communication device, which objects in an image captured on a mobile communication device correspond to a product;
determining, via the server, which of one or more products identified in the image have associated affinity information; and
communicating instructions to the mobile communication device, via the server, for presenting a display of the image on the mobile communication device, one or more affinity information indicators, each affinity information indicator presented proximate a location of the one or more products determined to have associated affinity information.

14. The method of claim 13, wherein identifying a product comprises identifying one or more images in a video stream captured on a mobile communication device that correspond to one or more products.

15. The method of claim 13, wherein identifying a product comprises identifying one or more objects in a still image captured on a mobile communication device that corresponds to one or more products.

16. The method of claim 13, wherein identifying a product comprises identifying one or more products based at least in part on global positioning system information associated with the mobile communication device or other information indicating a location of the mobile communication device.

17. An apparatus for providing affinity information, the apparatus comprising:
a server having a processor, a memory in communication with the processor, and
communication logic stored in the memory, executable by the processor and configured to receive data from a mobile communication device, the data corresponding to one or more objects in an image captured by the mobile communication device;
product identification logic stored in the memory, executable by the processor and configured to identify which objects in the video stream captured by the mobile communication device correspond to a product;
affinity information logic stored in the memory, executable by the processor and configured to determine whether the identified product has associated affinity information; and
affinity information presentation logic stored in the memory, executable by the processor and configured to communicate instructions for presenting, on a display of the mobile communication device, one or more affinity information indicators, each affinity information indicator presented proximate a location of the product determined to have associated affinity information.

18. The apparatus of claim 17, wherein the product identification logic is configured to identify one or more images in a video stream captured on a mobile communication device that correspond to one or more products.

19. The apparatus of claim 17, wherein the product identification logic is configured to identify one or more objects in a still image captured on a mobile communication device that corresponds to one or more products.

20. The apparatus of claim 17, wherein the product identification logic is configured to identify a product comprises identifying one or more products based at least in part on global positioning system information associated with the mobile communication device or other information indicating a location of the mobile communication device.

21. A computer program product comprising a non-transitory computer-readable medium comprising computer-executable instructions for execution on a server in communication with a mobile communication device, the instructions for providing affinity information, the instructions comprising:
instructions for identifying which objects in an image captured on a mobile communication device correspond to a product;
instructions for determining which of one or more products identified in the image have associated affinity information; and
instructions for communicating instructions to the mobile communication device for presenting one or more affinity information indicators in an image displayed on the mobile communication device, each affinity information indicator presented proximate a location of the one or more determined products.

22. The computer program product of claim 21, wherein identifying a product comprises identifying one or more images in a video stream captured on a mobile communication device that correspond to one or more products.

23. The computer program product of claim 21, wherein identifying a product comprises identifying one or more objects in a still image captured on a mobile communication device that corresponds to one or more products.

24. The computer program product of claim 21, wherein identifying a product comprises identifying one or more products based at least in part on global positioning system information associated with the mobile communication device or other information indicating a location of the mobile communication device.
